(19) United States
(12) Patent Application Publication
(10) Pub. No.: US 2020/0148512 A1
(43) Pub. Date: May 14, 2020

(54) CAR MOVER SYSTEMS AND METHOD

(71) Applicant: Manuel Herrera, Palmdale, CA (US)

(72) Inventor: Manuel Herrera, Palmdale, CA (US)

(21) Appl. No.: 16/541,128

(22) Filed: Aug. 14, 2019

Related U.S. Application Data
(60) Provisional application No. 62/685,233, filed on Jun. 14, 2018.

(51) Int. Cl. B66D 1/00

(52) U.S. Cl. CPC B66D 1/005

(57) ABSTRACT

A wheel mover assembly for a vehicle. The wheel mover assembly may include at least two wheels, an attachment means, a winch, and a motor. The wheel attachment may be bolted to 2-3 of the lugs on the tire. The at least two wheels may be located one on each side and may be used to counteract a torque of the motor turning the vehicle wheel. An outer wheel may contact the ground as it rotates. Further, a remote may be provided.

### CROSS-REFERENCE TO RELATED APPLICATION(S)

The present application is related to and claims priority to U.S. Provisional Patent Application No. 62/685,233 filed Jun. 14, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicles of existing art and more specifically relates to a vehicle moving means.

### RELATED ART

Many people in modern society drive vehicles for transportation between locations. Sometimes these vehicles can experience mechanical failures and may need to be moved to be worked on. It can be difficult for even the strongest people to push a disabled vehicle from a driveway into a garage or other short distances. Most people require help from at least one other person, but this isn't always practical and can slow down the productivity of a professional garage. Additionally, pushing disabled vehicles can lead to injuries, especially over time, including pulled or strained muscles, upper body and back pain, and more. A suitable solution is desired.

U.S. Pat. No. 4,135,681 to Wayne F. Cooper relates to a winch attachment for vehicle wheels. The described winch attachment for vehicle wheels includes a winch constructed to be removably attached to the driving wheel of a motor vehicle by means of the lug bolts of the vehicle. The winch comprises a hollow drum with flanges on each end. The inner one of the flanges has holes through it to receive the lug bolts of the vehicle wheel, and the drum has holes formed through it directly opposite each of the lug bolt receiving holes on this flange to accommodate the head of a wrench for tightening and loosening the lug bolts. The outer flange has holes through it aligned with the lug bolt receiving holes of the inner flange, so that the wrench can pass through these holes in the outer flange for attaching and removing the winch to and from the vehicle wheel. The outer flange also has an additional hole formed in it to facilitate the attachment of a cable or rope for use with the winch.

### SUMMARY OF THE INVENTION

In view of the foregoing disadvantages inherent in the known vehicles and winches art, the present disclosure provides a novel vehicle moving system. The general purpose of the present disclosure, which will be described subsequently in greater detail, is to provide an efficient, effective and safe means to move vehicles.

The present invention provides a simple and efficient way to move a disabled car a short distance. The device includes a remote control for superior convenience. It effectively eliminates the need to manually push a car, which typically requires help from another person. The device saves mechanics and at-home do-it-yourselfers a considerable amount of time and frustration. The present invention prevents strained or pulled muscles and other related injuries from occurring from pushing vehicles.

A vehicle moving system is disclosed herein, the system in a preferred embodiment comprising: a vehicle mover assembly including a frame; at least two (cylindrical) posts; at least two wheels; a motor with a (driven) shaft; a remote control; and an attacher (attachment means). The motor is located equidistantly between the at least two posts; the at least two posts coupled to the at least two wheels; the at least two wheels providing capability to move a vehicle (car or the like) relative to a (substantially) planar surface (such as the ground or driveway or the like). The motor is able to be coupled to the attacher via the attacher being coupled to the shaft of the motor and the attacher removably coupled to a vehicle-wheel. As designed, the motor of the vehicle mover assembly is able to be activated such that the vehicle is able to be moved relative to a planar surface.

In preferred embodiments the at least two wheels are caster wheels; wherein the caster wheels are able to rotate through 360 degrees of movement such that the disabled vehicle can be guided when the device is being used by pushing or pulling slightly on the vehicle body.

The motor is not attached to a winch; however alternate versions may comprise a winch. The motor is preferably integral with the frame and in alternative embodiments may be affixed to the frame. The motor is preferably electric with a 12 volt battery source. The motor is height adjustable in relation to the vehicle-wheel by movement of the frame in relation to the posts. For ease of use and convenience the motor is able to be locked in a static positioning via knob-locks or the like to maintain the height of the frame in relation to the posts. Relationally speaking the at least two posts are vertically-oriented during use and are perpendicular to the frame and parallel to the motor.

The attacher may be a wheel-mounting-plate; wherein the wheel-mounting-plate is able to be coupled and alternately decoupled (from the vehicle-wheel) via a quick-release-swivel-joint. As designed, the attacher is able to be threadingly-coupled to the vehicle-wheel via lugnuts (preferably three for safety and to not damage the studs). The vehicle is in ‘neutral’ when using the vehicle mover assembly such that it may be relatively free-wheeling. The remote control is in wireless communication with the vehicle mover assembly for use so the remote controller can control the device remotely for additional safety and ease. The vehicle moving system may further comprise a set of instructions and be arranged as a kit.

A method of use for the vehicle moving system is also disclosed herein, the method comprising the steps of: providing the vehicle moving system, the system comprising: a vehicle mover assembly including a frame; at least two posts; at least two wheels; a motor with a shaft; a remote control; and an attacher; coupling a wheel-mounting-plate to a shaft of the motor; adjusting a height of the motor relative to a vehicle-wheel; coupling the wheel-mounting-plate to the vehicle-wheel; and activating the motor to cause movement of a vehicle in relation to a substantially planar surface. The method may further comprise the step of remotely controlling the vehicle mover assembly via the remote control to move the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle moving system, constructed and operative according to the teachings of the present disclosure.

FIG. 1 is a perspective view of the vehicle moving system during an ‘in-use’ condition, according to an embodiment of the disclosure.

FIG. 2 is a perspective view of the vehicle moving system of FIG. 1, according to an embodiment of the present disclosure.

FIG. 3 is a perspective view of the vehicle moving system of FIG. 1, according to an embodiment of the present disclosure.

FIG. 4 is a perspective view of the vehicle moving system of FIG. 1, according to an embodiment of the present disclosure.

FIG. 5 is a perspective view of the vehicle moving system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicle moving means and more particularly to a vehicle moving system as used to improve the efficiency of moving of ‘dead/disabled’ vehicles between locations.

Generally, the present invention ‘Car Mover’ assists mechanics and others with moving a disabled vehicle short distances. This innovative product preferably comprises an apparatus with an electric motor with a 12-volt battery compartment, flanked between two posts. On the bottom of the posts can be caster wheels (or other such wheels to allow movement). The position of the motor can be adjusted up and down to align the front of the motor with the center of the wheel. Knobs can lock the motor in place after adjustments. Additionally, the front of the motor can accept a wheel-mounting plate via a quick-release swivel joint. The plate can be attached to a vehicle's wheel studs with three lugnuts (more or less may be used). Further, a remote control can power the device. In use, mechanics and at-home do-it-yourselfers can attach the device to the front, driver's side wheel on a front-wheel drive car for example. With the vehicle in neutral, users can move the vehicle by activating the motor via the remote control.

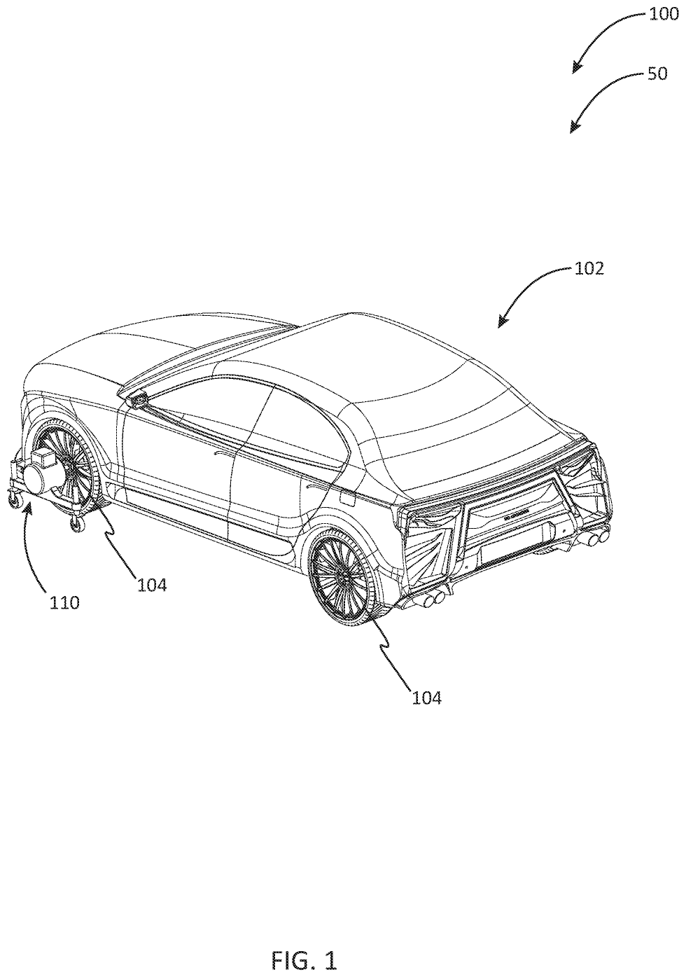

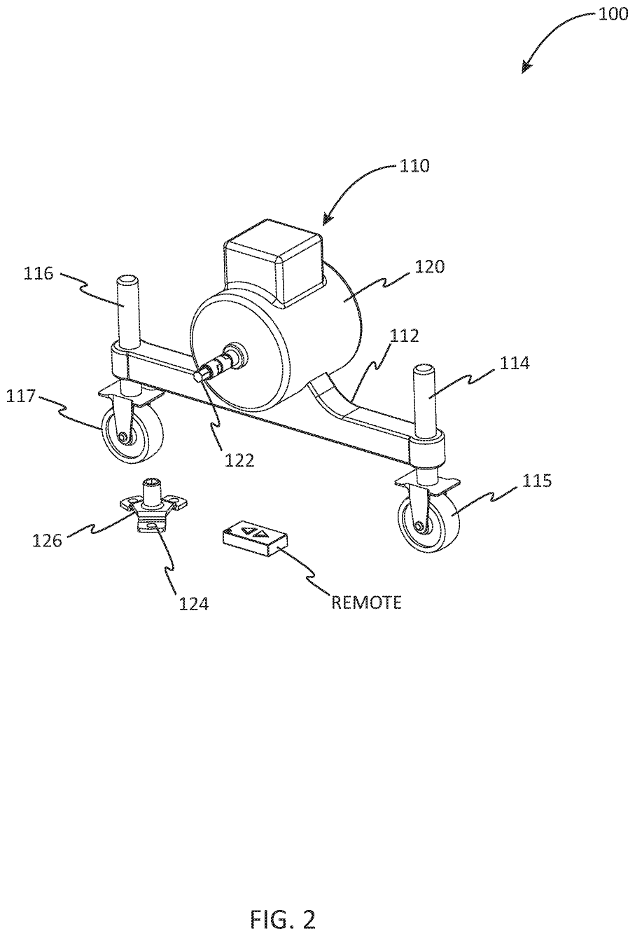

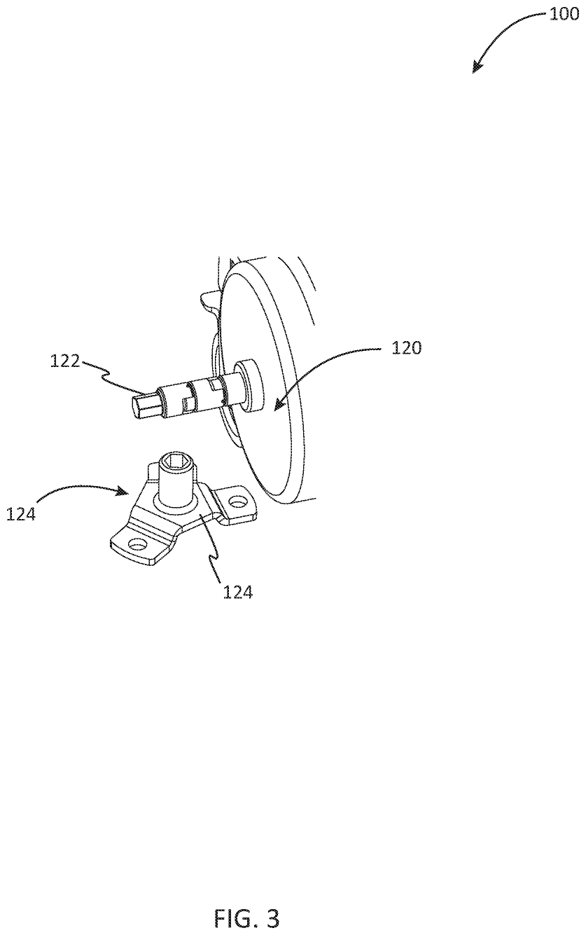

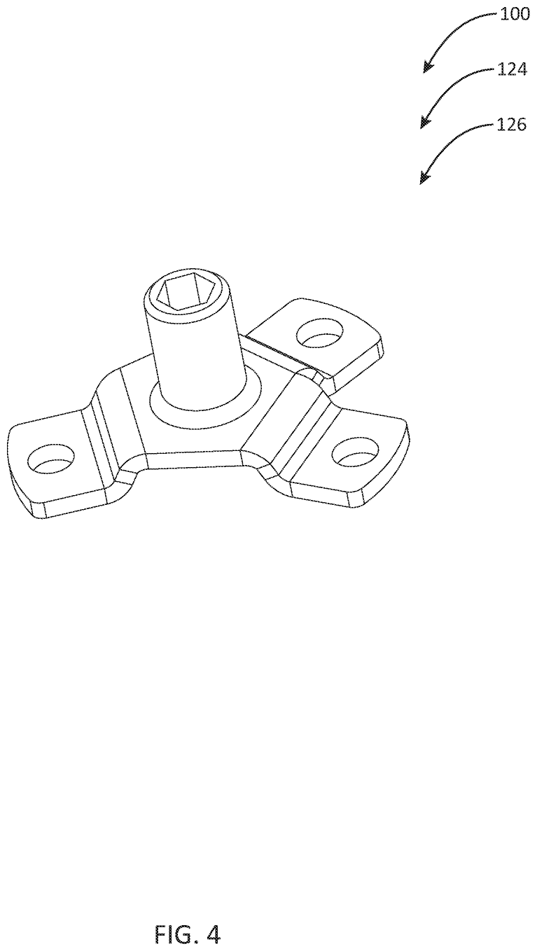

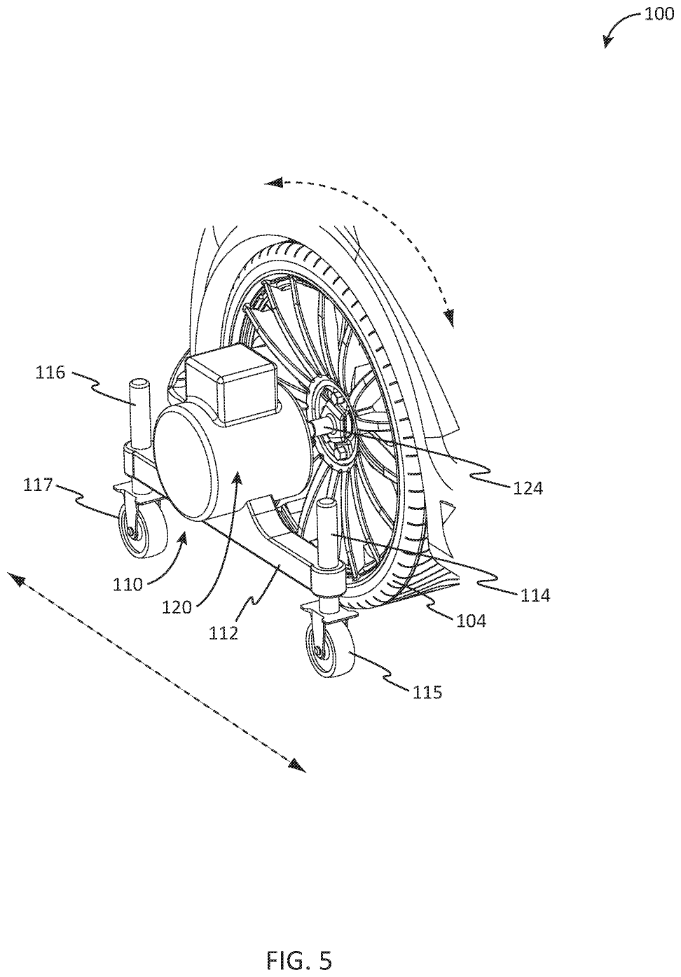

Referring now more specifically to the drawings by numerals of reference, there is shown in FIGS. 1-5, various views of a vehicle moving system 100.

FIG. 1 shows a vehicle moving system 100 during an ‘in-use’ condition 50, according to an embodiment of the present disclosure. Here, the vehicle moving system 100 may be beneficial for use by a user to move a disabled vehicle 102. As illustrated, the vehicle moving system 100 may comprise a vehicle mover assembly 110 including a frame 112; at least two posts 114 and 116; at least two wheels 115 and 117; a motor 120 with a shaft 122; and an attacher 124.

Referring now to FIGS. 1-5, the motor 120, as shown, is located between the at least two posts 114 and 116; the at least two posts 114 and 116 coupled to the at least two wheels 115 and 117, respectively; the at least two wheels 115 and 117 providing the capability to move a vehicle 102 relative to a (substantially) planar surface such as a ground surface or floor or driveway or the like. Certain embodiments may be made for rougher terrain with grips/knobs on the wheels 115 and 117 or for climbing inclines such as driveways. The motor 120 is able to be removably coupled to the attacher 124. The attacher 124 is coupled to the shaft 122 of the motor 120. The attacher 124 is removably coupled to a vehicle-wheel 104. The motor 120 of the vehicle mover assembly 110 is able to be activated such that the vehicle 102 is able to be moved relative to a planar surface. The motor 120 is not attached to a winch. A method of use is described hereinafter. The vehicle 102 is in neutral when using the vehicle mover assembly 110.

The motor 120 is preferably integral with the frame 112 however certain embodiments may not be integral. The motor 120 is preferably electric however other powering means may be used. The vehicle moving system 100 may further comprise a 12 volt battery source and the motor 120 may be height adjustable in relation to the vehicle-wheel 104. In adjustable embodiments the motor 120 is able to be locked in a static positioning via locks. Relationally speaking, the at least two posts 114 and 116 are vertically-oriented during use and are perpendicular to the frame 112 and parallel to the motor 120. Those with ordinary skill in the art will now appreciate that upon reading this specification and by their understanding the art of powering as described herein, methods of charging and manipulating electric motors via on/off means, remote controlling, etc. will be understood by those knowledgeable in such art.

Referring now to the attacher 124; the attacher 124 may be a wheel-mounting-plate 126. The wheel-mounting-plate 126 is able to be coupled and alternately decoupled via a quick-release-swivel-joint. The attacher 124 is able to be threadingly-coupled to the vehicle-wheel 104 via preferably at least three lugnuts. More or less may be used, however, at least three is preferred for safety and to not damage the threads on the studs.

Referring now to wheels 115 and 117 of the vehicle moving system 100; the at least two wheels 115 and 117 are preferably caster wheels. Other suitably equivalent wheels may be used as well as non-wheels such as for example tracks or the like. The caster wheels 115 and 117 preferred since they are able to rotate through 360 degrees of movement for ease of directing the vehicle 102. Certain embodiments of the vehicle moving system 100 may comprise a remote control. The remote control is in wireless communication with the vehicle mover assembly 110 for use.

According to one embodiment, the vehicle moving system 100 may be arranged as a kit. In particular, the vehicle moving system 100 may further include a set of instructions. The instructions may detail functional relationships in relation to the structure of the vehicle moving system 100 such that the vehicle moving system 100 can be used, maintained, or the like, in a preferred manner.

A method of use for the vehicle moving system 100 may include the steps of: step one, providing the vehicle moving system, the system comprising: a vehicle mover assembly including a frame; at least two posts; at least two wheels; a motor with a shaft; a remote control; and an attacher; step two, coupling a wheel-mounting-plate to a shaft of the motor; step three, adjusting the height of the motor relative to a vehicle-wheel; step four coupling the wheel-mounting-plate to the vehicle-wheel; and step five, activating the motor to cause movement of a vehicle in relation to a substantially planar surface. The method may further comprise the step six of remotely controlling the vehicle mover assembly via the remote control to move the vehicle. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use in moving vehicles (front-wheel and rear-wheel drive), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle moving system, the system comprising:
a vehicle mover assembly including
a frame;
at least two posts;
at least two wheels;
a motor with a shaft; and
an attacher;
wherein said motor is located between said at least two posts, said at least two posts coupled to said at least two wheels, said at least two wheels providing capability to move a vehicle relative to a planar surface, said motor coupled to said attacher, said attacher coupled to said shaft of said motor, said attacher removably coupled to a vehicle-wheel; and
wherein said motor of said vehicle mover assembly is able to be activated such that said vehicle is able to be moved relative to a planar surface.

2. The vehicle moving system of claim 1, wherein said at least two wheels are caster wheels.

3. The vehicle moving system of claim 2, wherein said caster wheels are able to rotate through 360 degrees of movement.

4. The vehicle moving system of claim 1, wherein said motor is not attached to a winch.

5. The vehicle moving system of claim 1, further comprising a remote control.

6. The vehicle moving system of claim 5, wherein the motor is integral with the frame.

7. The vehicle moving system of claim 6, wherein the motor is electric.

8. The vehicle moving system of claim 7, further comprising a 12 volt battery source.

9. The vehicle moving system of claim 8, wherein the motor is height adjustable in relation to said vehicle-wheel.

10. The vehicle moving system of claim 9, wherein the motor is able to be locked in a static positioning via locks.

11. The vehicle moving system of claim 1, wherein the attacher is a wheel-mounting-plate.

12. The vehicle moving system of claim 11, wherein the wheel-mounting-plate is able to be coupled and alternately decoupled via a quick-release-swivel-joint.

13. The vehicle moving system of claim 11, wherein the attacher is able to be threadingly-coupled to the vehicle-wheel via at least three lugnuts.

14. The vehicle moving system of claim 1, wherein the vehicle is in neutral when using said vehicle mover assembly.

15. The vehicle moving system of claim 5, wherein the remote control is in wireless communication with said vehicle mover assembly for use.

16. The vehicle moving system of claim 1, wherein the at least two posts are vertically-oriented during use and are perpendicular to said frame and parallel to said motor.

17. A vehicle moving system, the system comprising:
a vehicle mover assembly including
a frame;
at least two posts;
at least two wheels;
a motor with a shaft;
a remote control; and
an attacher;
wherein said motor is located between said at least two posts, said at least two posts coupled to said at least two wheels, said at least two wheels providing capability to move a vehicle relative to a planar surface, said motor coupled to said attacher, said attacher coupled to said shaft of said motor, said attacher removably coupled to a vehicle-wheel;
wherein said motor of said vehicle mover assembly is able to be activated such that said vehicle is able to be moved relative to a planar surface;
wherein said at least two wheels are caster wheels;
wherein said caster wheels are able to rotate through 360 degrees of movement;
wherein said motor is not attached to a winch;
wherein the motor is integral with the frame;
wherein the motor is electric with a 12 volt battery source;
wherein the motor is height adjustable in relation to said vehicle-wheel;
wherein the motor is able to be locked in a static positioning via knob-locks;
wherein the attacher is a wheel-mounting-plate;
wherein the wheel-mounting-plate is able to be coupled and alternately decoupled via a quick-release-swivel-joint;
wherein the attacher is able to be threadingly-coupled to the vehicle-wheel via lugnuts;
wherein the vehicle is in neutral when using said vehicle mover assembly;
wherein the remote control is in wireless communication with said vehicle mover assembly for use; and
wherein the at least two posts are vertically-oriented during use and are perpendicular to said frame and parallel to said motor.

18. The vehicle moving system of claim 17, further comprising set of instructions; and
wherein the vehicle moving system is arranged as a kit.

19. A method of use for the vehicle moving system, the method comprising the steps of:
providing a vehicle moving system, the system comprising:
a vehicle mover assembly including
a frame;
at least two posts;
at least two wheels;
a motor with a shaft;
a remote control; and
an attacher;
coupling a wheel-mounting-plate to a shaft of the motor;
adjusting a height of said motor relative to a vehicle-wheel;
coupling said wheel-mounting-plate to said vehicle-wheel; and
activating said motor to cause movement of a vehicle in relation to a substantially planar surface.

20. The method of claim 19, further comprising the step of remotely controlling said vehicle mover assembly via said remote control to move said vehicle.
